(19) United States
(12) Patent Application Publication
(10) Pub. No.: US 2010/0050801 A1
(43) Pub. Date: Mar. 4, 2010

(54) Ball screw module

(76) Inventor: Chang-Hsin KUO, Taichung city (TW)

Correspondence Address: SINORICA, LLC, 2275 Research Blvd., Suite 500, ROCKVILLE, MD, 20850, US

(21) Appl. No.: 12/263,548

(22) Filed: Nov. 3, 2008

(30) Foreign Application Priority Data
Aug. 29, 2008 (TW) 097133028

(51) Int. Cl. F16H 25/22; F16C 29/06; F16C 33/38

(52) U.S. Cl. 74/424.87

(57) ABSTRACT

Disclosed is a ball screw module including a screw shaft, a nut member, a ball connector, and a circulating device mounted on the nut member. The screw shaft and the nut member constitute a first load rolling track rolling in a first spiral direction. The circulating device is connected with the first load rolling groove and has a circulating route. The circulating route includes an intermediate route, connecting routes at the two ends of the intermediate route, and at least a guiding groove. The guiding groove guides the ball connector rotating in a second spiral direction along the connecting routes, wherein the second spiral direction is opposite to the first spiral direction. The guiding groove guides the ball connector rotating in a third spiral direction along the intermediate route, wherein the third spiral direction is the same as the first spiral direction.

### BACKGROUND OF THE INVENTION

1. Field of the Invention

The present invention relates to ball screw modules, and more particularly, to a ball screw module having a circulating device mounted on a nut member thereof.

2. Description of the Prior Art

The operating principles of a conventional ball screw shaft involve providing balls between a screw shaft and a nut member so as to replace the sliding friction transmission of an outdated acme screw shaft (ACME) with ball rolling motion, thereby reducing friction-induced wear and tear greatly and maintaining high efficiency and high preciseness.

Balls are effective in enabling a screw shaft to move smoothly. However, adjacent balls are, in the course of rolling, likely to collide with each other and therefore produce much noise. The collision shortens the service life of the balls and therefore shortens the service life of the screw shaft.

To solve the problems, the prior art disclosed a connector whereby balls are fixed in position. U.S. Pat. No. 5,993,064 further provides an improved ball connector made of resilient material and comprising four belt members for fixing a plurality of balls in position in all directions, and a ball connector capable of bending freely in all directions and yet keeping the respective positions of the balls unchanged, such that the ball connector is applicable to linear sliding and ball screw shafts.

However, a ball screw module requires a circulating route for guiding the balls returning to a spiral-shaped groove so as to travel along a continuous ball track. A ball connector passing the circulating route has to change its direction of movement so as for the ball connector to follow a loop. An improperly designed circulating route is likely to prevent a ball connector from passing a circulating route smoothly and changing direction. Ball connectors disclosed in the prior art tend to sever when twisted and pulled unduly. Referring to FIG. 1, U.S. Pat. No. 5,993,064 taught a ball connector for use with a screw shaft, and taught a nut member having a circulating device disposed therein so as to enable the ball connector to go through a loop. U.S. Pat. No. 5,993,064 failed to teach how to enable the ball connector to pass the circulating device smoothly. In practice, the two lateral sides of a ball connector undergo 3D revolutions while traveling from a spiral track to a circulating device. If angles of a revolving route is not specially designed, a ball connector traveling along the revolving route is likely to have its inner side squeezed and its outer side pulled and therefore sever due to a difference between its inner and outer sides in deformation. Although linear rolling tracks using ball connectors are commercially available, ball screw shafts adopting ball connectors remain unavailable in terms of design and fabrication.

### SUMMARY OF THE INVENTION

To solve the aforesaid problems, it is the primary objective of the present invention to provide a ball screw module comprising a ball connector revolving smoothly in a nut member so as to achieve high performance and high preciseness of the ball screw module.

Another objective of the present invention is to provide a ball screw module comprising a nut member, and a circulating device mounted on the nut member and configured to move a ball connector along a continuous circulating route (endless track).

The circulating device of the present invention at least comprises a guiding groove (preferably two guiding grooves) for guiding a ball connector, so as to guide the ball connector through revolutions smoothly. The length of the guiding grooves in each section approximates to the length of the center line of the circulating route such that, while the ball connector is turning around at a bend of the circulating route, the length of the center line of the ball connector approximates to the length of the guiding grooves laterally (or bilaterally) provided for the ball connector, thereby preventing the ball connector from being pushed or dragged which might otherwise occur in the presence of a great difference in length between the guiding grooves and the ball connector in a section. Hence, the present invention allows the ball connector to move smoothly without being dragged or pushed unduly.

A ball screw module of the present invention essentially comprises a screw shaft, a nut member, a ball connector, and a circulating device. The screw shaft has an outer surface provided with a spiral-shaped first load rolling groove. The nut member is circumferentially disposed around the screw shaft and has an inner surface provided with a spiral-shaped second load rolling groove corresponding in position to the first load rolling groove. The first and second load rolling grooves together form a spiral-shaped first rolling track. The first rolling track rolls in a first spiral direction. The aforesaid spiral direction is right-handed or left-handed. A right-handed spiral direction of advance is defined by the direction of the thumb of the right hand with the other four fingers of the right hand bending and pointing at the direction of revolution. Conversely, a left-handed spiral direction of advance is defined by the direction of the thumb of the left hand with the other four fingers of the left hand bending and pointing at the direction of revolution. The ball connector, which moves within the first rolling track, comprises a plurality of balls and a connector for carrying the balls. The connector further comprises a plurality of intervals and at least a linking strap. The connector is reinforced by means of two linking straps, namely a first linking strap and a second linking strap. The balls are fixed in position and spaced apart from each other by the intervals. The first linking strap and/or the second linking strap are configured to connect the intervals in series. The first linking strap and the second linking strap are spaced apart from each other by a distance, allowing the balls to be steadily positioned between the intervals, the first linking strap, and the second linking strap. The circulating device, which is mounted on the nut member, comprises a circulating route with two ends in communication with the first rolling track. The cross-sectional radius of the circulating route is slightly greatly than the radii of the balls so as to enable the ball connector to pass the circulating route. To guide the ball connector moving smoothly, the circulating route further comprises an intermediate route and connecting routes each having one end in communication with a corresponding one of the two ends of the intermediate route. The other end of each of the connecting routes is in communication with the first rolling track. The circulating route is further provided with a guiding groove formed along the circulating route. In the situation where the connector has two linking straps, the number of the guiding grooves must be two. The guiding grooves are configured to guide the first linking strap and/or the second linking strap of the ball connector. As disclosed in the present invention, construction and configuration of the guiding grooves are based on 3D geometrical analysis and are configured to guide the ball connector revolving, in the connecting route, relative to the center line of the circulating route and in the second spiral direction, wherein the second spiral direction is opposite to the first spiral direction in which the first rolling track rolls. If the first spiral direction is right-handed, the second spiral direction is left-handed. Conversely, if the first spiral direction is left-handed, the second spiral direction is right-handed. The guiding grooves guide the ball connector revolving, in the intermediate route, relative to the center line of the circulating route and in the third spiral direction, wherein the third spiral direction is the same as the first spiral direction. The ball connector take the course in the sequence “connecting route—intermediate route—connecting route” so as to go through all the bends and loops smoothly.

Compared to the prior art, the present invention has the following advantages. A circulating device of a ball screw module of the present invention is equipped with special guiding grooves twisted in different directions along a circulating route having connecting routes and an intermediate route, so as to guide a ball connector through bends and looping. The length of the guiding grooves bilaterally (or laterally) provided for the circulating route approximates to the length of the circulating route, and thus linking straps of the ball connector are unlikely to be dragged or pushed unduly while passing the circulating route.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a cross-sectional view of a ball screw module and a ball connector thereof according to the prior art;

FIG. 2 is a perspective view of a nut member and a screw shaft of the ball screw module according to the present invention;

FIG. 3 is a cross-sectional view of a ball screw module, a ball connector thereof, and a circulating device thereof according to the present invention;

FIG. 4 is a cross-sectional view of a second load rolling groove on the inner surface of the nut member of the ball screw module according to the present invention;

FIG. 5 is a cross-sectional view of a first rolling track of the ball screw module according to the present invention;

FIG. 6 is a perspective view of the ball connector of the ball screw module according to the present invention;

FIG. 7 is a perspective view of a connector of the ball connector of the ball screw module and the direction in which the connector in a circulating route turns along a guiding groove according to the present invention;

FIG. 8A is a perspective view of the nut member and the circulating device of the ball screw module according to the present invention;

FIG. 8B is a schematic drawing showing the lower half of the circulating device of the ball screw module according to the present invention;

FIG. 8C is a schematic drawing showing the upper half of the circulating device of the ball screw module according to the present invention, taken from an upward perspective view point;

FIG. 9A is an exploded view of the internal-circulating ball screw module according to the present invention;

FIG. 9B is a schematic drawing showing the assembly of the ball connector, the circulating device, and the inside of the nut member of the internal-circulating ball screw module according to the present invention;

FIG. 10A is an exploded view of the circulating component-style ball screw module according to the present invention; and

FIG. 10B is a schematic drawing showing the inner structure of the nut member of the circulating component-style ball screw module according to the present invention.

### DETAILED DESCRIPTION OF THE EMBODIMENTS

The present invention is directed to a ball screw module which comprises a screw shaft, a nut member, and a circulating device and is based on mechanism transmission principles comprehensible to persons ordinarily skilled in the related art, and thus the related mechanism transmission principles are not described in detail hereunder. Also, the accompanying drawings solely serve an illustrative purpose and therefore are not drawn to scale.

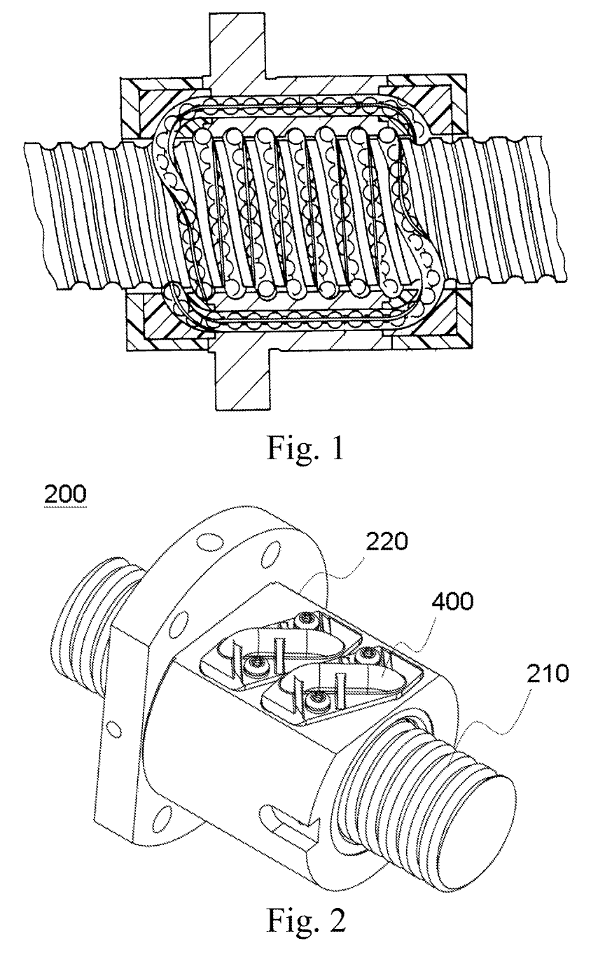

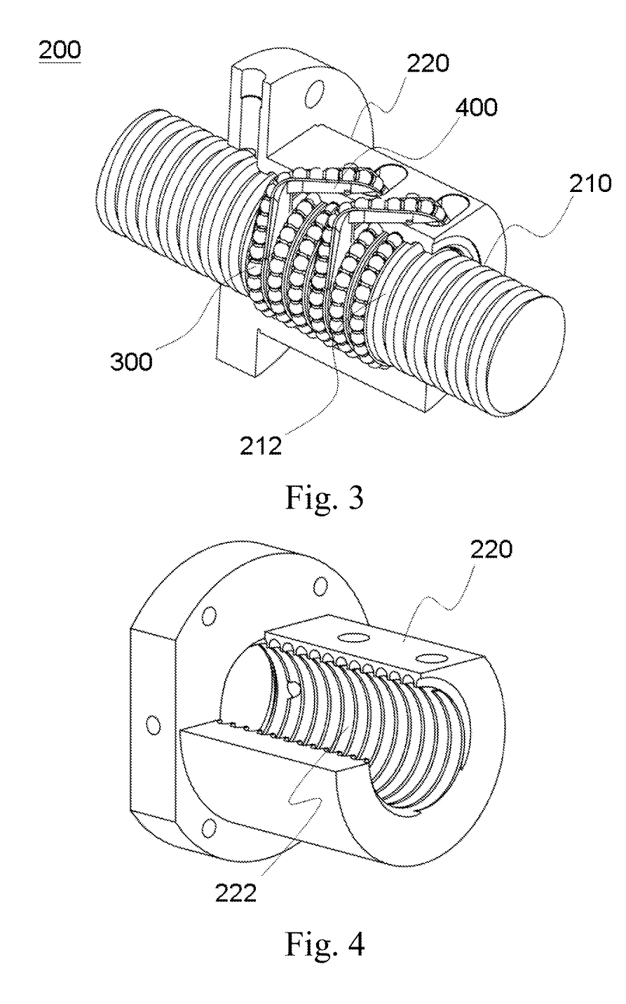

Referring to FIGS. 2, 3, 4 and 5, the present invention provides a first preferred embodiment wherein a ball screw module 200 comprises a screw shaft 210, a nut member 220, a ball connector 300, and a circulating device 400. The screw shaft 210 has an outer surface provided with a spiral-shaped first load rolling groove 212. The nut member 220 is circumferentially disposed around the screw shaft 210 and has an inner surface provided with a spiral-shaped second load rolling groove 222 corresponding in position to the first load rolling groove 212. The first load rolling groove 212 and the second load rolling groove 222 together form a spiral-shaped first rolling track 230 so as for a ball connector 300 to move around in first rolling track 230. The first rolling track 230 rolls in a first spiral direction S₁/M₁, allowing the nut member 220 revolving in a first screw direction S₁ shown in FIG. 3 to move in a first moving direction M₁. In the first preferred embodiment, the first spiral direction S₁/M₁ is right-handed. The number of the circulating devices 400 is one or more.

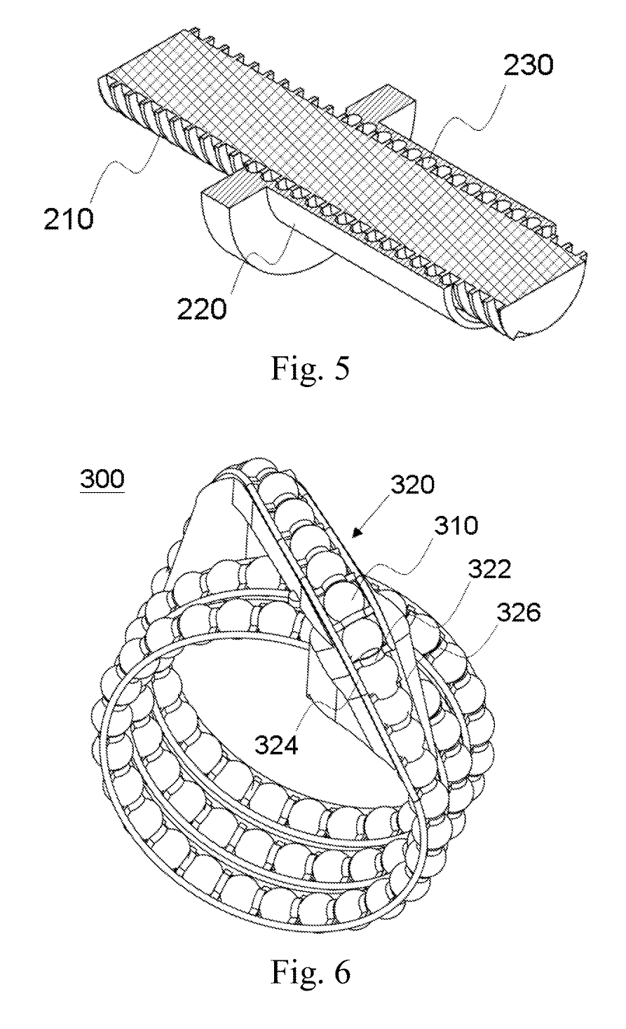

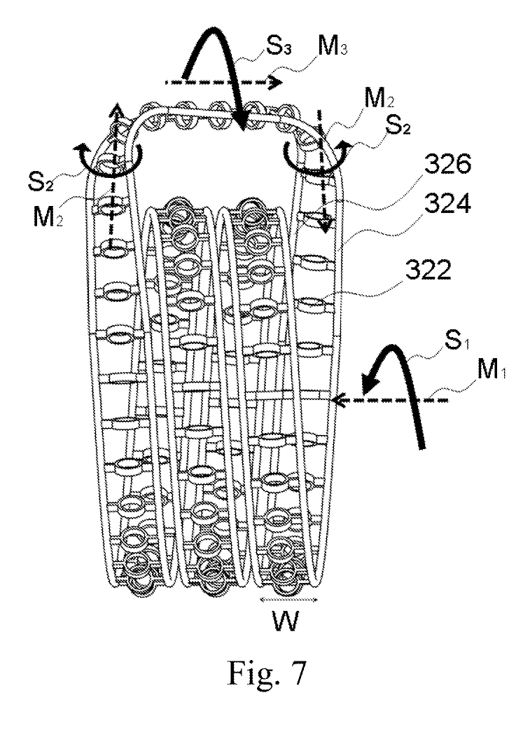

Referring to FIGS. 5, 6 and 7, a ball connector 300 essentially comprises a plurality of balls 310 and a connector 320 for carrying the balls 310. The connector 320 further comprises a plurality of intervals 322 and linking straps. In the first preferred embodiment, the connector 320 is reinforced by means of two linking straps, namely a first linking strap 324 and a second linking strap 326. Each of the two linking straps is disposed across the outer (peripheral) surface of the screw shaft 210 and an inner (orificial) surface of the nut member 220, allowing the linking straps to move smoothly along a slit between the screw shaft 210 and the nut member 220; as a result, it is not necessary to form, optionally, a space on the screw shaft 210 or the nut member 220 to receive the two linking straps in motion. The intervals 322 are configured to space apart the balls 310. The first linking strap 324 and the second linking strap 326 are configured to connect the intervals 322 in series. The first linking strap 324 and the second linking strap 326 are spaced apart from one another by a distance W. The distance W approximates to the diameter of the balls 310, allowing the balls 310 to be steadily positioned between the intervals 322, the first linking strap 324, and the second linking strap 326. The ball connector 300 moves within the first rolling track 230. To achieve precise transmission, preferably, the cross-sectional radius of the first rolling track 230 is roughly equal to the radii of the balls 310.

Referring to FIGS. 3, 5, 8A, 8B, and 8C, the ball screw module 200, which is configured to guide the ball connector 300 to the first rolling track 230, comprises the circulating device 400 mounted on the nut member 220 and provided with a circulating route 410. The circulating route 410 communicates with the first rolling track 230, thereby forming a continuous circulating route (endless track). Preferably, the cross-sectional width of the circulating route 410 is roughly greater than the diameter of the balls 310. The circulating route 410 comprises an intermediate route 412 and connecting routes 414 each having one end in communication with a corresponding one of two ends of the intermediate route 412. The intermediate route 412 is substantially straight. The center line of the intermediate route 412 and the axis of the screw shaft 210 are skewed with respect to each other yet without intersection therebetween. The intermediate route 412 and the connecting routes 414 of the circulating route 410 are further provided with two guiding grooves 416 configured to allow the first linking strap 324 and the second linking strap 326 of the ball connector 300 to pass. The length of the two guiding grooves 416 in each section approximates to the length of the center line of the circulating route 410.

Referring to FIGS. 3, 5, 7, 8A, 8B, and 8C, to enable the ball connector 300 to pass the circulating device 400 and then return to the spiral-shaped first rolling track 230, the guiding grooves 416 have to guide the ball connector 300 changing the original direction in which the ball connector 300 travels in the first rolling track 230 and then guide the ball connector 300 restoring the original direction in which the ball connector 300 travels in the first rolling track 230 as follows:

To enable the guiding grooves 416 to guide the ball connector 300 passing the connecting routes 414, the outer length of the guiding grooves 416 must decrease and the inner length of the guiding grooves 416 must increase such that, in the course of the turning of the connecting routes 414 entering the intermediate route 412, the guiding grooves 416 should equal the center line of the circulating route 410 in length as much as possible. The guiding grooves 416 guide the ball connector 300 revolving around the center of the circulating route in a second spiral direction S₂/M₂, allowing the ball connector 300 moving in a second moving direction M₂ to revolve in a second screw direction S₂, wherein the second spiral direction S₂/M₂ is opposite to the first spiral direction S₁/M₁ in which the first rolling track 230 rolls. In the first preferred embodiment, the second spiral direction S₂/M₂ is left-handed. It is because that the connecting routes 414 and the intermediate route 412 assume spherical three-dimensional configuration from a cross-sectional perspective, and thus the guiding grooves 416 should tilt toward the inside of a bend so as to decrease the length of the guiding grooves 416. Conversely, the guiding grooves 416 should tilt toward the outside of a bend so as to increase the length of the guiding grooves 416. Hence, the present invention teaches adjusting the length of the two guiding grooves 416 by means of the three-dimensional spatial characteristics. To enable the guiding grooves 416 to guide the ball connector 300 passing the intermediate route 412, the guiding grooves 416 guide the ball connector 300 revolving around the center of the circulating route in a third spiral direction S₃/M₃, allowing the ball connector 300 moving in a third moving direction M₃ to revolve in a third screw direction S₃, wherein the third spiral direction S₃/M₃ is the same as the first spiral direction S₁/M₁ in which the first rolling track 230 rolls. In the first preferred embodiment, the third spiral direction S₃/M₃ is right-handed.

The connector of the ball screw module is configured to carry the balls and space apart the intervals by a fixed distance so as to prevent the balls in motions from colliding with each other, thereby prolonging the service life the balls. Also, with the guiding grooves being formed in the circulating device, the ball connector changes its own direction while traveling along a specific route within the circulating device, thereby allowing the ball connector to revolve continuously. Since the length of the guiding grooves which flank the ball connector are equal and roughly amount to the length of the center line of the circulating route, the first linking strap and the second linking strap of the ball connector are unlikely to be dragged or pushed unduly in the turning sections, and in consequence the ball connector moves around within the ball screw module smoothly and efficiently.

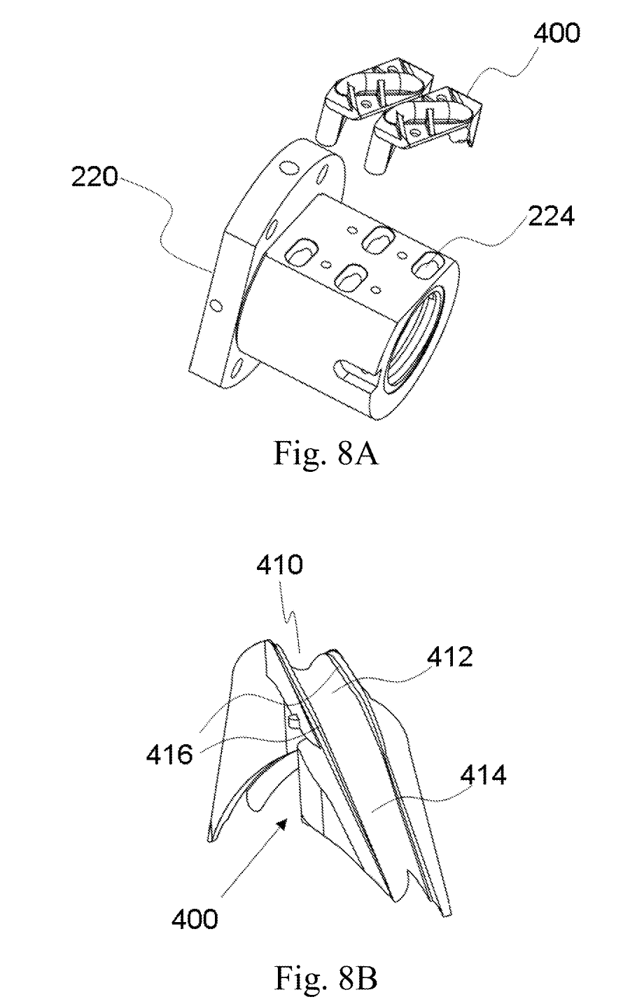

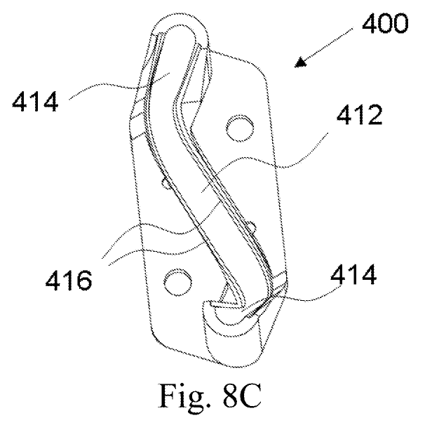

Referring to FIGS. 8A, 8B, and 8C, the present invention further provides a second preferred embodiment wherein the ball screw module comprises the circulating device 400 and the nut member 220. One, two, or a plurality of said circulating devices 400 are mounted on the nut member 220. In the second preferred embodiment, the nut member 220 further has a plurality of mounting holes 224 formed to penetrate the nut member, configured to hold the circulating device 400 in position, and configured to fix a portion of the circulating device 400 in position outside the nut member 220. The circulating device 400 has the circulating route 410. The circulating route 410 includes an intermediate route 412 and the connecting routes 414 at two ends of the intermediate route 412. The intermediate route 412 and the connecting routes 414 of the circulating route 410 are further provided with two guiding grooves 416. The essential features of the circulating device 400 in the second preferred embodiment are the same as those of the circulating device 400 in the first preferred embodiment.

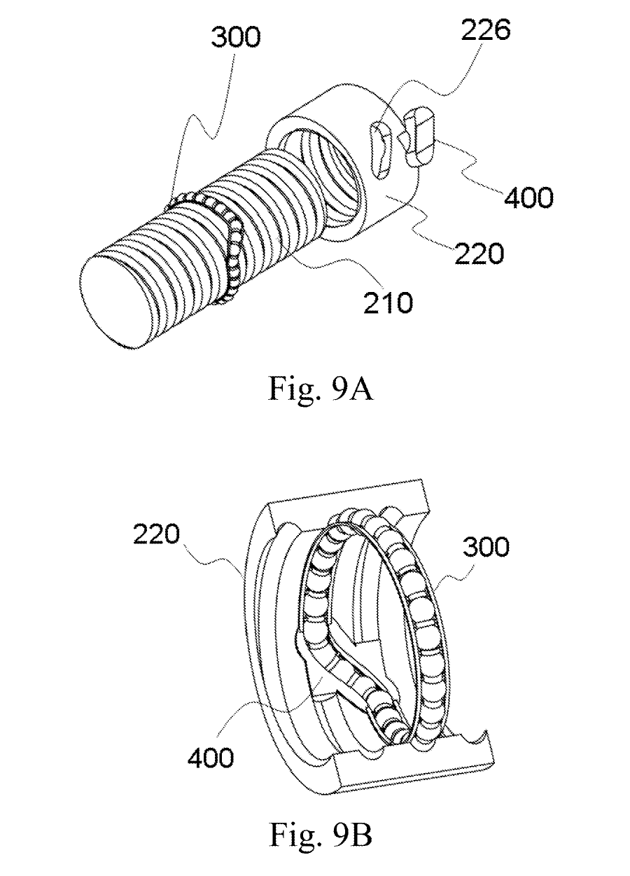

Referring to FIGS. 9A and 9B, the present invention further provides a third preferred embodiment wherein the ball screw module comprises the circulating device 400 and the nut member 220 disposed in the ball screw module, and more particularly a nut member disposed in the internal-circulating ball screw module. In the third preferred embodiment, the inner surface of the nut member 220 further has a first through hole 226 so as for the circulating device 400 to be disposed in the first through hole 226. The essential features of the circulating device 400 in the third preferred embodiment are the same as those of the circulating device 400 in the first preferred embodiment.

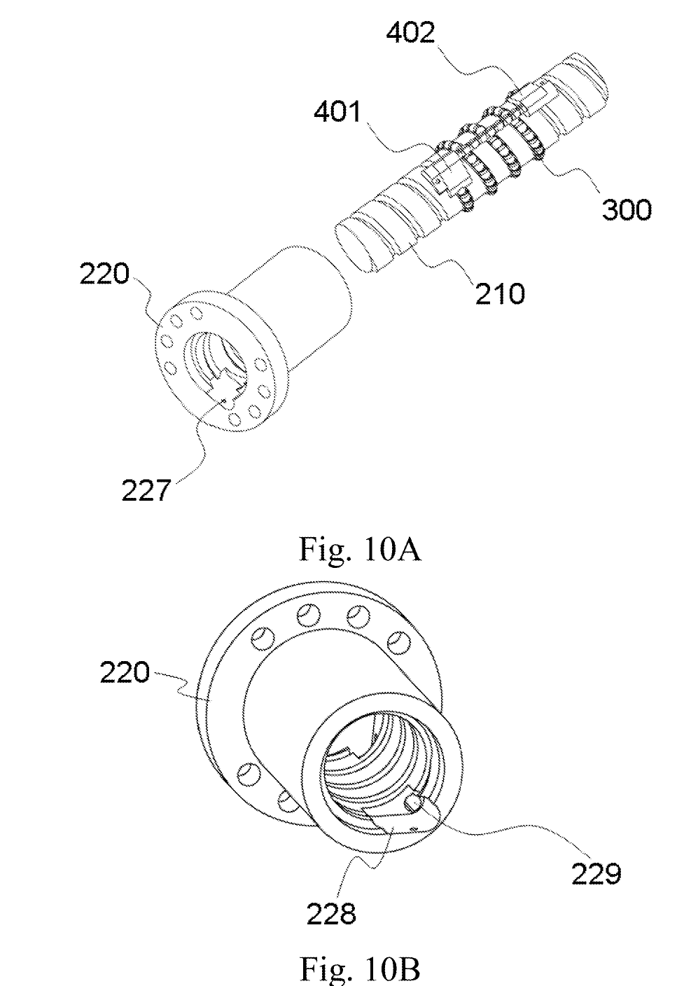

Referring to FIGS. 10A and 10B, the present invention further provides a fourth preferred embodiment wherein the ball screw module comprises the circulating device 400 and the nut member 220 disposed in the ball screw module, and more particularly a nut member disposed in the circulating component-style ball screw module. The nut member 220 comprises two slots 227, 228 and a second through hole 229 in communication with the two slots 227, 228. The circulating device comprises two circulating components 401, 402 provided within the two slots 227, 228. The circulating device has the circulating route. The circulating route comprises the intermediate route and the connecting routes each having one end in communication with a corresponding one of the two ends of the intermediate route. The intermediate route is positioned within the first through hole 229. The connecting routes are positioned within two circulating components 401, 402, respectively. The essential features of the circulating device in the fourth preferred embodiment are the same as those of the circulating device 400 in the first preferred embodiment.

The foregoing specific embodiments are only illustrative of the features and functions of the present invention but are not intended to restrict the scope of the present invention. It is apparent to those skilled in the art that all equivalent modifications and variations made in the foregoing embodiment according to the spirit and principle in the disclosure of the present invention should fall within the scope of the appended claims.

1. A ball screw module, comprising:
a screw shaft having an outer surface provided with a spiral-shaped first load rolling groove;
a nut member circumferentially disposed around the screw shaft and having an inner surface provided with a spiral-shaped second load rolling groove corresponding in position to the first load rolling groove, wherein the first load rolling groove and the second load rolling groove together form a spiral-shaped first rolling track rolling in a first spiral direction; and
a ball connector capable of moving around in the first rolling track and comprising a plurality of balls and a connector for carrying the balls, the connector comprising:
a plurality of intervals for spacing apart the balls; and
linking straps for connecting the intervals in series;
wherein a circulating device is mounted on the nut member and provided with a circulating route for the ball connector to pass and the circulating route comprises an intermediate route and connecting routes each having one end in communication with a corresponding one of two ends of the intermediate route, in which the connecting routes each has another end in communication with the first rolling track;
said circulating device being characterized in that:
the intermediate route and the connecting routes at the two ends thereof of the circulating route are formed with a guiding groove for guiding the ball connector revolving along the two connecting routes in a second spiral direction and guiding the ball connector revolving along the intermediate route in a third spiral direction, wherein the second spiral direction is opposite to the first spiral direction, and the third spiral direction is the same as the first spiral direction.

2. The ball screw module of claim 1, wherein the intermediate route is substantially straight.

3. The ball screw module of claim 2, wherein a center line of the intermediate route and an axis of the screw shaft are skewed with respect to each other yet without intersection therebetween.

4. The ball screw module of claim 1, wherein the first rolling track has a cross-sectional radius substantially equal to radii of the balls.

5. The ball screw module of claim 1, wherein the circulating route has a cross-sectional radius greater than radii of the balls.

6. The ball screw module of claim 1, wherein a length of the guiding groove in each section approximates to a length of a center line of the circulating route.

7. The ball screw module of claim 1, wherein the nut member further has a plurality of mounting holes formed to penetrate the nut member, configured to hold the circulating device in position, and configured to fix a portion of the circulating device in position outside the nut member.

8. The ball screw module of claim 1, wherein the inner surface of the nut member further has a first through hole so as for the circulating device to be disposed in the first through hole.

9. The ball screw module of claim 1, wherein the nut member further comprises:
two slots formed at two ends inside the nut member; and
a second through hole for communicating with the two slots.

10. The ball screw module of claim 9, wherein the circulating device further comprises two circulating components disposed in the two slots.

11. The ball screw module of claim 10, wherein the intermediate route is positioned in the second through hole, and the connecting routes are positioned in the circulating components.

12. The ball screw module of claim 1, wherein the linking straps are disposed across the outer surface of the screw shaft and the inner surface of the nut member so as for the linking straps to move along a slit between the screw shaft and the nut member.
